(19) United States
(12) Patent Application Publication
(10) Pub. No.: US 2025/0084680 A1
(43) Pub. Date: Mar. 13, 2025

(54) OBJECT WITH MAGNETIC SWITCH MECHANISM

(71) Applicant: Medimaging Integrated Solution, Inc., Hsinchu Science Park (TW)

(72) Inventor: HAO CHANG CHIANG, Hsinchu (TW)

(21) Appl. No.: 18/661,223

(22) Filed: May 10, 2024

(30) Foreign Application Priority Data
Sep. 11, 2023 (TW) 112209769

(51) Int. Cl. E05C 19/16; E05F 1/12

(52) U.S. Cl. CPC E05C 19/16; E05F 1/1207

(57) ABSTRACT

An object with a magnetic switch mechanism includes a body, a first magnetic element, a cover, and a switch component. The body has an opening and a limit slide slot, wherein the limit slide slot is located on one end of the opening. The first magnetic element is set inside the body and close to the opening. The cover is attached to another end of the opening and used to cover the opening. The switch component is set on the limit slide slot and press-fitted with the cover to keep the cover covering the opening. The switch component alternates between a state where the cover covers the opening and a state where the cover is unlocked to reveal the opening, by translating in a first direction between a press-fit position and an unlocked position. A second magnetic element is set inside the switch component arranged parallel to the first magnetic element. The switch component is kept in the press-fit position due to the magnetic force between the first and second magnetic elements.

### BACKGROUND OF THE INVENTION

### 1. Field of the Invention

The present invention relates to a switch mechanism technology, particularly to a mechanism switched magnetically.

### 2. Description of the Prior Art

At present, many products have covers, such as electronic products, for covering special openings. However, corresponding switch mechanisms must be used in those covers so as to open/close the covers repeatedly.

The conventional technologies have provided some mechanisms to realize the function of opening/closing covers repeatedly, including elastic mechanisms, press-fit mechanisms, and adhesive mechanisms.

Refer to FIG. 1. In the elastic mechanism, a switch 2 is disposed in a slide slot 1, and springs 3 are fixed to one end of the slide slot 1. The user may apply force to the surface of the switch 2 to bend the springs 3 and control the opening/closing of a cover 4. However, the springs 3 must be operated symmetrically on both sides lest uneven forces cause the switch 2 to jam. Besides, the friction between the springs 3 and the slide slot 1 may induce the springs 3 to distort and impair the operation of the switch 2.

The press-fit mechanism is also a commonly-seen design, which uses the press-fit between elements to keep the cover hooding the opening, especially the openings of the battery bays of toys. However, the elements of the press-fit mechanism are likely to fracture because of repeated compression or force application.

The adhesive (hook-and-loop) mechanism is another commonly-seen design, which uses adhesive (hook-and-loop fasteners) to fix covers. Although the adhesive (hook-and-loop) mechanism is simple, it is hard to guarantee that the cover is completely closed. Besides, the cover may be damaged after the cover has been used for a period of time.

The conventional technologies have provided some solutions to realize the function of opening/closing openings repeatedly. However, they still have some limitations and drawbacks. For example, the symmetry and the influence of friction must be taken into consideration in using the elastic mechanisms; applying force inappropriately may damage the cover in using the press-fit mechanisms; the adhesive (hook-and-loop) mechanisms are hard to guarantee complete sealing.

### SUMMARY OF THE INVENTION

Considering the drawbacks of the conventional technologies, the existing switch mechanisms need improving to overcome the problems of the conventional technologies. For example, new materials or structures are used to improve the problems of symmetry and friction of elastic switch mechanisms; press-fit switch mechanisms are designed to obtain higher durability; more reliable adhesive (hook-and-loop) materials are provided to improve adhesive (hook-and-loop) switch mechanisms, whereby to achieve better performance of opening/closing covers repeatedly. Besides, automatic technologies may be taken into consideration to make users able to operate switch mechanisms more conveniently and precisely to open/close covers repeatedly. Nevertheless, the automatic technologies for switch mechanisms have the disadvantages of expensiveness. Considering the problems of the conventional technologies and the abovementioned viewpoints, the primary objective of the present invention is to provide an improved switch mechanism.

According to the abovementioned objective, the present invention provides an object with a magnetic switch mechanism, which comprises a body, a first magnetic element, a cover, and a switch component. The body has an opening and a limit slide slot, and the limit slide slot is located on one side of the opening. The first magnetic element is disposed inside the body and close to the opening. The cover is attached to one side of the opening for covering the opening. The switch component is disposed on the limit slide slot and used to press-fit with the cover to keep it covering the opening. The switch component alternates between a state where the cover covers the opening and a state where the cover is unlocked to reveal the opening, by translating in a first direction between a press-fit position and an unlocked position. A second magnetic element is disposed inside the switch component, and the second magnetic element is arranged parallel to the first magnetic element. The magnetic force between the first magnetic element and the second magnetic element keeps the switch component in the press-fit position.

In one embodiment, a horizontal distance exists between a central point of the second magnetic element inside the switch component and a central point of the first magnetic element inside the body. The horizontal distance makes the switch component having the second magnetic element attracted or repulsed by the magnetic force and kept at the press-fit position within the limit slide slot.

In one embodiment, a length of the limit slide slot and a position where the limit slide slot is located on the surface of the body are set to make the first magnetic element and the second magnetic element separated by the horizontal distance.

In one embodiment, the cover further includes a first fixing protrusion at one end where the cover is press-fitted with the switch component. The limit slide slot further includes a fixing socket at one end of the limit slide slot, which is near the opening. The first fixing protrusion is inserted into the first fixing socket, and the magnetic force maintains the state that the first fixing protrusion is inserted into the first fixing socket.

In one embodiment, the cover also includes a second fixing protrusion, which is disposed on a surface of the first fixing protrusion. The switch component further includes a second fixing socket, which is disposed on a surface of the switch component, which is near the opening and faced to the limit slide slot, whereby the second fixing protrusion can be inserted into the second fixing socket.

In one embodiment, the limit slide slot further includes a limit member. The limit member is disposed on another end of the limit slide slot, which is opposite to the opening. The limit member is extended upward along a direction, which is vertical to the first direction. The switch component further includes an extension member. The extension member is on another end of the switch component, which is opposite to the opening. The extension member is extended upward along a direction vertical to the first direction. The limit member presses against the extension member to limit a displacement of the switch component, which is generated by the magnetic force.

In one embodiment, the object with a magnetic switch mechanism further comprising a buffer element. The buffer element is disposed on one side of the cover, which faces the opening.

In one embodiment, the buffer element is vertically extended by a height, which is greater than a distance between the cover and the opening, whereby the buffer element is compressed while the cover covers the opening.

In one embodiment, the cover further includes a connection member. The cover is pivotally coupled to one side of the opening via the connection member.

In one embodiment, the connection member is connected with an elastic member. The elastic member provides a counter force to make the cover detached from the switch component.

According to the abovementioned statements, the Inventor may advocate that the present invention has the following efficacies: (1) it is only two magnets that the magnetic switch mechanism of the present invention uses to generate the magnetic force for enabling the switch component to press-fit with the cover, whereby the present invention is exempted from the problem that the uneven applied force or friction induces the components to be jammed or damaged; (2) the magnetic switch mechanism of the present invention staggers the positions of two magnets to control the movement direction of the switch component, whereby the switch component can operate smoother in cooperation with the slide slot; (3) the present invention may use the configuration of several groups of magnets to achieve multidirectional operations, whereby the present invention may provide diversified switch-control methods.

The objective, technologies, features and advantages of the present invention will become apparent from the following description in conjunction with the accompanying drawings wherein certain embodiments of the present invention are set forth by way of illustration and example.

### BRIEF DESCRIPTION OF THE DRAWINGS

The foregoing conceptions and their accompanying advantages of this invention will become more readily appreciated after being better understood by referring to the following detailed description, in conjunction with the accompanying drawings, wherein:

FIG. 1 shows a conventional spring-type switch mechanism;

FIG. 2 is a perspective view schematically showing an object with a magnetic switch mechanism according to one embodiment of the present invention, wherein the cover is in a locked state;

FIG. 3 is a perspective view schematically showing an object with a magnetic switch mechanism according to one embodiment of the present invention, wherein the switch component is pushed to an unlocked position;

FIG. 4 is a perspective view schematically showing an object with a magnetic switch mechanism according to one embodiment of the present invention, wherein the switch component is restored to the original position;

FIG. 5 is a locally-enlarged view schematically showing an object with a magnetic switch mechanism according to one embodiment of the present invention, wherein the cover is in a locked state;

FIG. 6 is a locally-enlarged view schematically showing an object with a magnetic switch mechanism according to one embodiment of the present invention, wherein the switch component is pushed to an unlocked position;

FIG. 7 is a locally-enlarged view schematically showing an object with a magnetic switch mechanism according to one embodiment of the present invention, wherein the switch component is restored to the original position;

FIGS. 8A and 8B include two diagrams schematically showing the actions of the magnetic force upon the magnetic switch mechanism according to one embodiment of the present invention; and

FIG. 9 is a locally-enlarged view schematically showing an object with a magnetic switch mechanism according to one embodiment of the present invention, wherein the cover is in an unlocked state.

### DESCRIPTION OF THE PREFERRED EMBODIMENTS

Various embodiments of the present invention will be described in detail below and illustrated in conjunction with the accompanying drawings. In addition to these detailed descriptions, the present invention can be widely implemented in other embodiments, and apparent alternations, modifications and equivalent changes of any mentioned embodiments are all included within the scope of the present invention and based on the scope of the Claims. In the descriptions of the specification, in order to make readers have a more complete understanding about the present invention, many specific details are provided; however, the present invention may be implemented without parts of or all the specific details. In addition, the well-known steps or elements are not described in detail, in order to avoid unnecessary limitations to the present invention. Same or similar elements in Figures will be indicated by same or similar reference numbers. It is noted that the Figures are schematic and may not represent the actual size or number of the elements. For clearness of the Figures, some details may not be fully depicted.

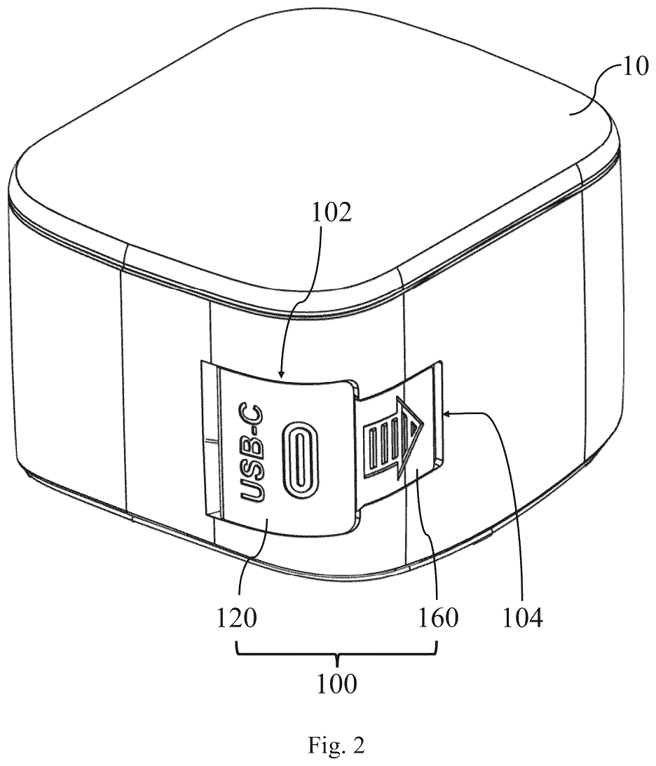

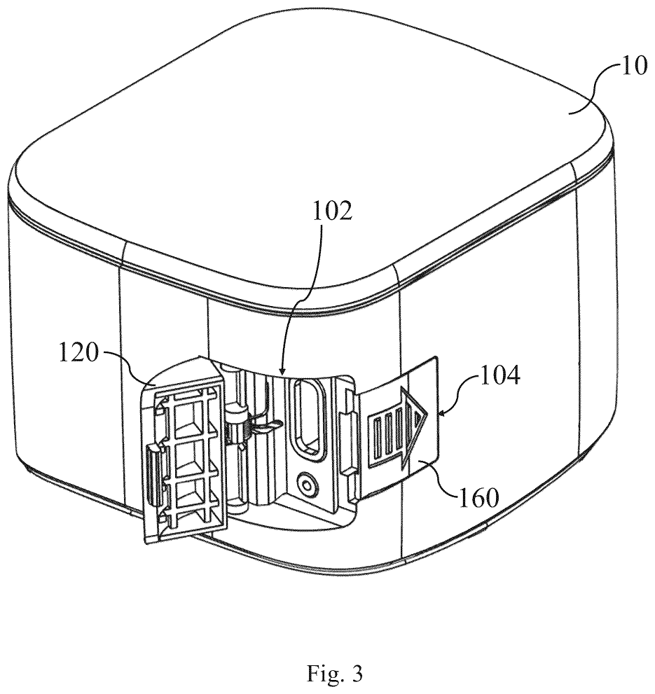

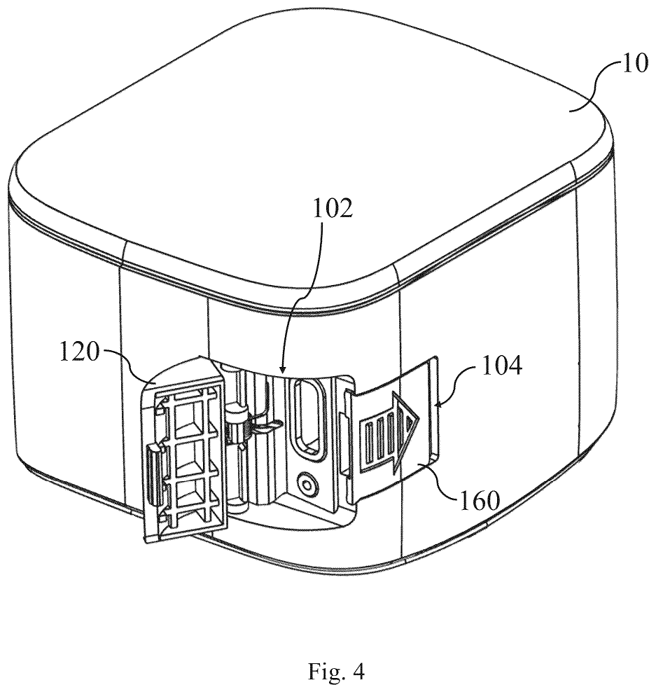

Simultaneously refer to FIGS. 2-4, which show that a switch mechanism 100 is disposed on the surface of a body 10. FIG. 2 shows that a cover 120 is in a locked state, wherein a switch component 160 is in a press-fit position. FIG. 3 shows that the switch component 160 is pushed to an unlocked position. FIG. 4 shows that the switch component 160 is restored to the press-fit position.

In one embodiment, the body 10 has a magnetic element, as shown in FIG. 2. The cover 120 is coupled to one side of an opening 102 and used to cove the opening 102. A limit slide slot 104 is disposed on the surface of the body 10. The limit slide slot 104 is located at another side of the opening 102 and near a first magnetic element. The switch component 160 is disposed inside the limit slide slot 104, used to press-fit with the cover 10 and keep the cover 120 covering the opening 102.

As shown in FIG. 3, while the user pushes the switch component 160 toward the limit slide slot 104 to make the cover 120 depart from the switch component 160, the opening 102 is revealed.

As shown in FIG. 4, a second magnetic element is disposed inside the switch component 160 and arranged parallel to the first magnetic element. Thus, the magnetic force between the first magnetic element and the second magnetic element may make the switch component 160 be restored to the original position where the switch component 160 was located before the switch component 160 was pushed.

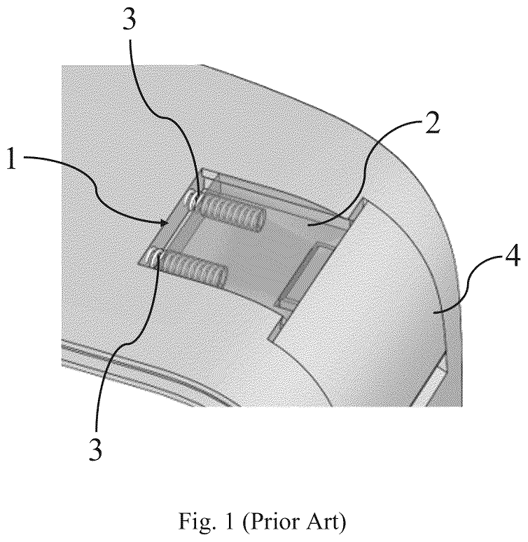

Therefore, it is the magnetic force between the first magnetic element and the second magnetic element that keeps the cover 120 in the closed state shown in FIG. 1. Hence, although no additional force is applied to the switch component 160, the switch component 160 can still press-fit with the cover 120 persistently.

In some embodiments, the body 10 may be a container of a 3C (Computer, Communication, and Consumer) product, a household appliance or an electronic instrument. Alternatively, the body 10 may be an arbitrary container.

In some embodiments, the cover 120 may be a dust-proof cover, a water-proof cover, or an airtight cover.

In some embodiments, the surface of the cover 120 may be engraved with text or a symbol (such as USB-C), which is corresponding to the functional socket or port disposed inside the opening 102, such as a charging socket or an information transmission port.

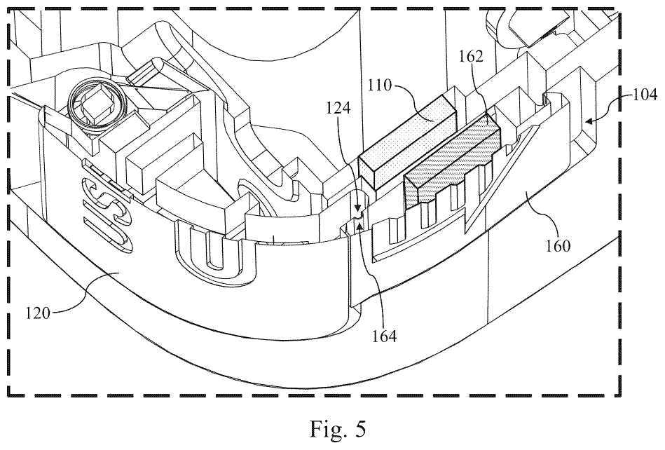

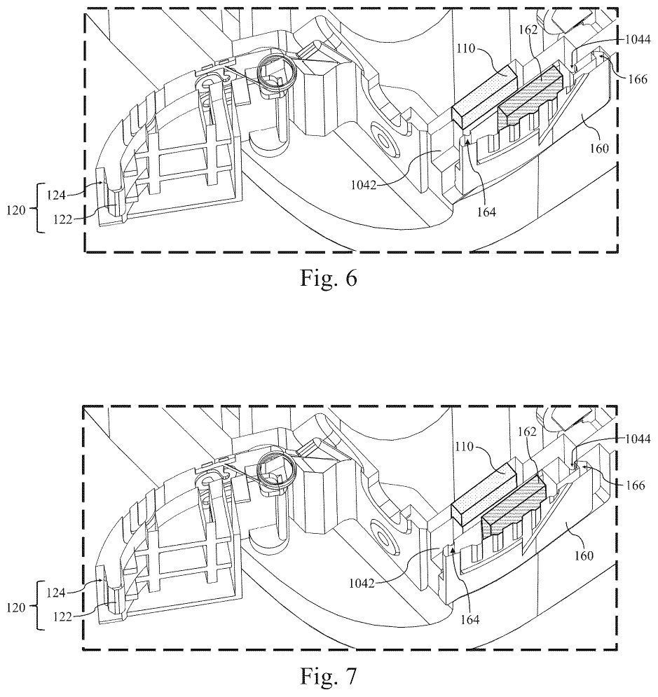

Refer to FIGS. 5-7, and refer to FIGS. 2-4 again. FIGS. 5-7 show locally-enlarged views of the object with a magnetic switch mechanism. FIG. 5 shows that the cover 120 is in a locked state, wherein the switch component 160 is in a press-fit position. FIG. 6 shows that the switch component 160 is pushed to an unlocked position. FIG. 7 shows that the switch component 160 is restored to the press-fit position.

Refer to FIG. 5. In one embodiment, the present invention provides an object with a magnetic switch mechanism, which comprises a body 10, a first magnetic element 110, a cover 120, and a switch component 160. The body 10 includes an opening 102 and a limit slide slot 104. The limit slide slot 104 is disposed on one side of the opening 102. The first magnetic element 110 is disposed inside the body 10 and near the opening 102. The cover 120 is coupled to another side of the opening 102 and used to cover the opening 102. The switch component 160 is disposed on the limit slide slot 104, press-fitted with the cover 120 to keep the cover 120 covering the opening 102. The switch component 160 alternates between a state where the cover 120 covers the opening 102 and a state where the cover 120 is unlocked to reveal the opening 102, by reciprocating in a first direction between a press-fit position and an unlocked position. A second magnetic element 162 is disposed inside the switch component 160, and the second magnetic element 162 is arranged parallel to the first magnetic element 110. The magnetic force between the first magnetic element 110 and the second magnetic element 162 keeps the switch component 160 in the press-fit position.

Refer to FIG. 6. While the user pushes the switch component 160 along the limit slide slot 104, the cover 120 departs from the switch component 160 to reveal the opening 102.

Refer to FIG. 7. Because the second magnetic element 162 is disposed inside the switch component 160 and arranged parallel to the first magnetic element 110, the magnetic force between the first magnetic element 110 and the second magnetic element 162 will restore the switch component 160 to the original position where the switch component 160 was located before the user pushed the switch component 160.

Refer to FIGS. 5-7 again. In some embodiments, the cover 120 further includes a first fixing protrusion 122 at the end where the cover 120 is press-fitted with the switch component 160; the limit slide slot 104 further includes a fixing socket 1042 at one end of the limit slide slot 104, which is near the opening 102; the first fixing protrusion 122 is inserted into the first fixing socket 1042, and the magnetic force maintains the state that the first fixing protrusion 122 is inserted into the first fixing socket 1042. In details, while the switch component 160 is located at the press-fit position, the first fixing protrusion 122 is exactly inserted into the first fixing socket 1042 to form a press-fit state, whereby the cover 120 can cover the opening 102.

Further, the cover 120 also includes a second fixing protrusion 124, which is disposed on the surface of the first fixing protrusion 122. The switch component 160 further includes a second fixing socket 164, which is disposed on the surface of the switch component 160, which is near the opening 102 and faced to the limit slide slot 104, whereby the second fixing protrusion 124 can be inserted into the second fixing socket 164.

Refer to FIGS. 5-7 again. In some embodiments, the limit slide slot 104 further includes a limit member 1044. The limit member 1044 is disposed on another end of the limit slide slot 104, which is opposite to the opening 102 and extended upward along a direction, which is vertical to the first direction, wherein the first direction is from the press-fit position of the limit slide slot 104 to the unlock position of the limit slide slot 104. The switch component 160 further includes an extension member 166. The extension member 166 is at one side of the switch component 160, which is opposite to the opening 102, and extended upward along a direction vertical to the first direction. The limit member 1044 presses against the extension member 166 to limit the displacement of the switch component 160, which is generated by the magnetic force, i.e. to constrain the switch component 160 between the press-fit position and the unlocked position of the limit slide slot 104.

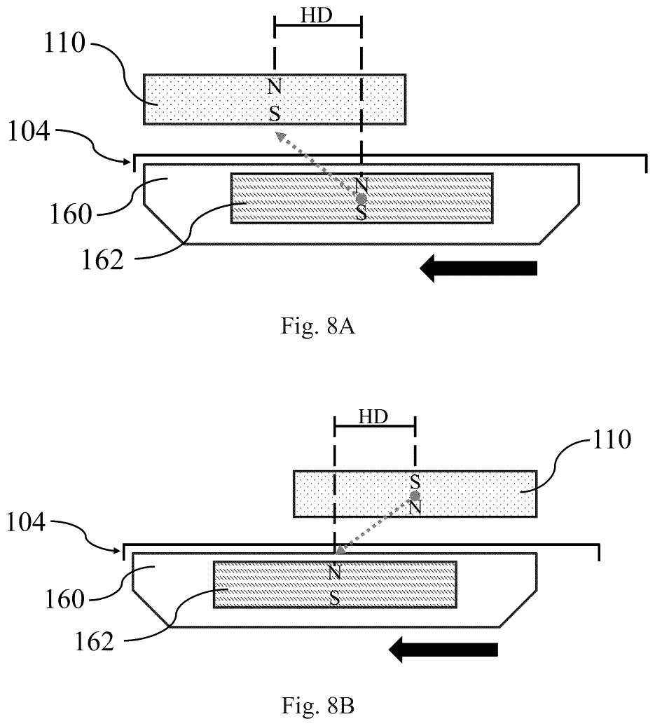

Refer to FIG. 8A and FIG. 8B, and refer to FIGS. 5-7 again. FIG. 8A and FIG. 8B schematically show the actions of the magnetic force upon the magnetic switch mechanism of the present invention.

In one embodiment, a horizontal distance HD exists between the central point of the second magnetic element 162 inside the magnetic element 160 and the central point of the first magnetic element 110 inside the body 10. The horizontal distance HD makes the switch component 160 having the second magnetic element 162 be attracted or repulsed by the magnetic force, and the switch component 160 is kept at the position within the limit slide slot 104.

Refer to FIG. 8A. In some embodiments, the attractive force of opposite magnetic polarities (indicated by the dotted-line arrow) attracts the switch component 160 to the first magnetic element 110. In other words, the attractive force keeps the switch component 160 press-fitted to the cover 120, wherein the solid-line arrow indicates the direction of the movement induced by the opposite-polarities attraction.

Refer to FIG. 8B. In some embodiments, the repulsive force of identical magnetic polarities (indicated by the dotted-line arrow) repulses the switch component 160 to the first magnetic element 110. In other words, the repulsive force keeps the switch component 160 press-fitted to the cover 120, wherein the solid-line arrow indicates the direction of the movement induced by the identical-polarities repulsion.

The function shown in FIG. 8A or FIG. 8B will be achieved according to any one of the embodiments described below:
(1) Make the central points of the first and second magnetic elements 110 and 162 be separated by the horizontal distance HD via adjusting the position where the limit slide slot 104 is located at the surface of the body 10.
(2) Make the central points of the first and second magnetic elements 110 and 162 be separated by the horizontal distance HD via adjusting the length of the limit slide slot 104. The length of the limit slide slot 104 should not be too large lest the first and second magnetic elements 110 and 162 be attracted to each other. If the limit slide slot 104 is too long, the switch component 160 is unlikely to be restored to its original position.
(3) Make the central points of the first and second magnetic elements 110 and 162 be separated by the horizontal distance HD via press-fitting the switch component 160 with the component of the limit slide slot 104, such as press-fitting the abovementioned extension member 166 to the limit member 1044.

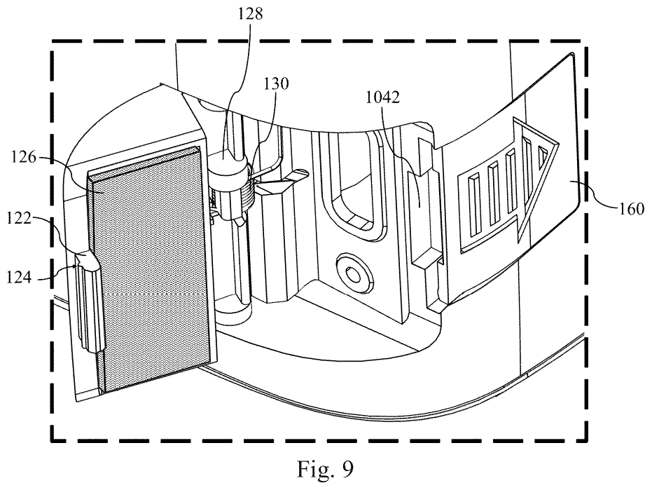

Refer to FIG. 9. FIG. 9 schematically shows a locally-enlarged view of the object with a magnetic switch mechanism of the present invention.

In one embodiment, the magnetic switch mechanism 100 further includes a buffer element 126. The buffer element 126 is disposed on one side of the cover 120, which faces the opening 102.

In details, the buffer element 126 is vertically extended by a height, which is greater than the distance between the cover 120 and the opening 102, whereby the buffer element 126 is compressed while the cover 120 covers the opening 102. While the cover 120 departs from the press-fit state with the switch component 160, the compression of the buffer element 126 is released, and the cover 120 is thus bounced out. The buffer element 126 may be made of sponge, silica gel, rubber, or any compressible material.

In some embodiments, the cover 120 further includes a connection member 128. The cover 120 is pivotally coupled to one side of the opening 102 via the connection member 128. The connection member 128 is connected with an elastic member 130. While the cover 120 departs from the press-fit state with the switch component 160 (the switch component 160 is pushed to the unlock position), the elastic member 130 provides counter force to make the cover 120 depart from the switch component 160. The elastic member 130 may be a torsion spring.

Hence, according to any one of the abovementioned embodiments, the present invention can achieve the following efficacies:

Simplifying design: The magnetic switch mechanism uses less components than the conventional technologies, whereby the overall structure becomes simpler, more lightweight, more economical in fabrication, and easy to assemble and maintain.

Enhancing durability: The present invention adopts magnetic material to realize the switching function. In comparison with the conventional mechanical structures, the magnetic switch mechanism is free of mechanical components that are likely to be worn out. Therefore, the magnetic switch mechanism of the present invention has higher durability and longer service life.

Improving safety: The required components are decreased in the present invention. Thus, the present invention can operate smoother, and the risk of injuring users is reduced. Therefore, the present invention is particularly suitable for toys and household appliances, which are operated frequently.

Expanding application: the magnetic switch mechanism of the present invention is applicable to various products, such as electronic products, household appliances, vehicles, and toys. Further, the present invention can be flexibly designed to adapt to different applications.

Increasing integration capability: The magnetic switch mechanism of the present invention is simpler and smaller. Therefore, the present invention is convenient to integrate with other intelligent technologies, such as the IoT technology. Thus, the present invention can improve the competitiveness in automation and intelligentization for the products.

While the invention is susceptible to various modifications and alternative forms, a specific example thereof has been shown in the drawings and is herein described in detail. It should be understood, however, that the invention is not to be limited to the particular form disclosed, but to the contrary, the invention is to cover all modifications, equivalents, and alternatives falling within the appended claims.

What is claimed is:

1. An object with a magnetic switch mechanism, comprising
a body, having an opening and a limit slide slot, wherein the limit slide slot is disposed on one end of the opening;
a first magnetic element, disposed inside the body and close to the opening;
a cover, coupled to another end of the opening and used to cover the opening; and
a switch component, disposed on the limit slide slot and press-fitted with the cover to make the cover keep covering the opening, wherein the switch component switches between a state where the cover covers the opening and a state where the cover is unlocked to reveal the opening, by translating in a first direction between a press-fit position and an unlocked position, and wherein a second magnetic element is disposed inside the switch component arranged parallel to the first magnetic element; a magnetic force between the first magnetic element and the second magnetic element keeps the switch component in the press-fit position.

2. The object with a magnetic switch mechanism according to claim 1, wherein a horizontal distance exists between a central point of the second magnetic element inside the switch component and a central point of the first magnetic element inside the body; the horizontal distance makes the switch component having the second magnetic element attracted or repulsed by the magnetic force and kept at the press-fit position within the limit slide slot.

3. The object with a magnetic switch mechanism according to claim 2, wherein a length of the limit slide slot and a position where the limit slide slot is located on the surface of the body are set to make the first magnetic element and the second magnetic element separated by the horizontal distance.

4. The object with a magnetic switch mechanism according to claim 1, wherein the cover further includes a first fixing protrusion at one end where the cover is press-fitted with the switch component; the limit slide slot further includes a fixing socket at one end of the limit slide slot, which is near the opening; the first fixing protrusion is inserted into the first fixing socket, and the magnetic force maintains the state that the first fixing protrusion is inserted into the first fixing socket.

5. The object with a magnetic switch mechanism according to claim 4, wherein the cover also includes a second fixing protrusion, which is disposed on a surface of the first fixing protrusion; the switch component further includes a second fixing socket, which is disposed on a surface of the switch component, which is near the opening and faced to the limit slide slot; the second fixing protrusion can be inserted into the second fixing socket.

6. The object with a magnetic switch mechanism according to claim 2, wherein the limit slide slot further includes a limit member; the limit member is disposed on another side of the limit slide slot, which is opposite to the opening, and extended upward along a direction, which is vertical to the first direction; the switch component further includes an extension member; the extension member is on another side of the switch component, which is opposite to the opening, and extended upward along a direction vertical to the first direction; the limit member presses against the extension member to limit a displacement of the switch component, which is generated by the magnetic force.

7. The object with a magnetic switch mechanism according to claim 1, further comprising a buffer element, wherein the buffer element is disposed on one side of the cover, which faces the opening.

8. The object with a magnetic switch mechanism according to claim 7, wherein the buffer element is vertically extended by a length, which is greater than a distance between the cover and the opening; the buffer element is compressed while the cover covers the opening.

9. The object with a magnetic switch mechanism according to claim 1, wherein the cover further includes a connection member; the cover is pivotally coupled to one end of the opening via the connection member.

10. The object with a magnetic switch mechanism according to claim 9, wherein the connection member is connected with an elastic member; the elastic member provides a counter force to make the cover detached from the switch component.
